(19) United States
(12) Patent Application Publication
(10) Pub. No.: US 2026/0064079 A1
(43) Pub. Date: Mar. 5, 2026

(54) WATCH COMPRISING A SHOCK-RESISTANT DIAL

(71) Applicant: Certina S.A., Le Locle (CH)

(72) Inventors: Yoann Mosteiro Vazquez, Montmagny (CH); Yann Aeschbacher, Moutier (CH); Simon Garcin, Salavaux (CH); Joslain Bossy, Yverdon-les Bains (CH); Philipp Tschumi, Niederwil (CH); Steve Gerber, La Neuveville (CH); Anthony Sipp, Domdidier (CH)

(73) Assignee: Certina S.A., Le Locle (CH)

(21) Appl. No.: 19/271,256

(22) Filed: Jul. 16, 2025

(30) Foreign Application Priority Data
Sep. 4, 2024 (EP) 24198462.4

(51) Int. Cl. G04B 37/04; G04B 37/00

(52) U.S. Cl. CPC G04B 37/04; G04B 37/0008

(57) ABSTRACT

A watch (100) including a middle (10), a detachable back (12) mounted on the middle (10), and a movement (20) housed in an inner volume (15) of the middle (10). The watch also includes a dial (40), with a thickness (e₃), having an upper face (41) visible to the user, the dial (40) being attached to a reinforcement piece (30) positioned under the dial (40), the reinforcement piece (30) including a peripheral annular shoulder (36) engaging with an annular shoulder (16) formed in the middle (10), the reinforcement piece (30) being attached to the middle (10) pressing against the annular shoulder (16) of the middle (10).

### CROSS REFERENCE TO RELATED APPLICATIONS

This application claims priority to European Patent Application No. 24198462.4, filed on Sep. 4, 2024, the entire contents of which are incorporated herein by reference.

### TECHNICAL FIELD OF THE INVENTION

The invention relates to a watch comprising a shock-resistant dial.

### TECHNOLOGICAL BACKGROUND

Conventionally, a watch comprises a middle, a glass and a detachable back. A horology movement is held in the middle by casing elements.

A dial visible through the glass is fastened to the horology movement.

It is common knowledge that an accidental shock to the watch can damage or mark certain components of the horology movement, or even cause certain components to detach.

Solutions have been developed to minimize the effects of shocks on the horology movement, in particular by inserting a shock absorber between the middle and the horology movement.

However, the horology movement is not the only component that can be damaged by an accidental shock to the watch.

In fact, the dial fastened to the horology movement can also be damaged or deformed by a shock to the watch.

There is therefore a need to improve dials to address at least one of the problems outlined above.

### SUMMARY OF THE INVENTION

The invention primarily aims to provide a watch comprising a shock-resistant dial with improved shock resistance.

To this end, the invention aims to provide a watch comprising a middle, a detachable back mounted on the middle, and a movement housed in an inner volume of the middle.

According to the invention, the watch comprises a dial with a thickness e₃, comprising an upper face visible to the user, the dial being attached to a reinforcement piece positioned under the dial, the reinforcement piece comprising a peripheral annular shoulder engaging with an annular shoulder formed in the middle, said reinforcement piece being attached to the middle and pressing against the annular shoulder of the middle.

Such a reinforcement piece helps minimize the bending of the dial if the watch receives a shock. Thus, for the same dial (that is, made of the same material and with the same thickness), the shock-resistant dial according to the invention significantly reduces the bending of the dial by at least twofold if the watch is dropped from a height of 1 metre.

Thus, the shock-resistant dial according to the invention makes it possible to provide a simple and cost-effective solution without the need to use other expensive and more complex materials to manufacture a dial.

The shock-resistant dial according to the invention makes it possible to provide reinforced support over the entire surface of the dial and to attach the dial directly to the middle to minimize strain and distortion of the dial.

In addition to the characteristics mentioned in the previous paragraph, the watch according to the invention can have one or more complementary characteristics from among the following, taken individually or in any technically possible combination:
the dial is rigidly pressed against an upper face of the reinforcement piece; preferentially, the dial is integrally and rigidly pressed against the upper face of the reinforcement piece;
the dial has a central portion and a peripheral portion and in that the central portion and the peripheral portion are rigidly pressed against the upper face of the reinforcement piece;
the reinforcement piece has a central portion with a thickness e₁ and a peripheral portion on which the peripheral annular shoulder is formed, the peripheral portion having a thickness e₂, the thickness e₂ of the peripheral portion being greater than the thickness e₁ of the central portion and greater than the thickness e₃ of the dial;
the thickness e₂ of the peripheral portion is at least twice the thickness e₁ of the central portion 31 and/or greater than the thickness e₃ of the dial;
the reinforcement piece is screwed onto the middle;
the reinforcement piece is attached to the middle by screwing it onto the annular shoulder of the middle;
the watch comprises a clamp ring, separate from the detachable back, screwed onto the middle and arranged to compress the reinforcement piece axially against the annular shoulder of the middle;
the clamp ring comprises, on an outer circumference, a threading that engages with a tapping formed in the middle;
the tapping in the middle used for clamping the clamp ring is configured such that the detachable back (12) can be screwed thereon;
the dial is made in one piece with the reinforcement piece;
the dial is glued to the upper face of the reinforcement piece using an adhesive element;
the dial is screwed onto the upper face of the reinforcement piece by screwing means;
the dial is attached by brazing or soldering to the upper face of the reinforcement piece;
the movement is cased in the middle using the reinforcement piece.

### BRIEF DESCRIPTION OF THE FIGURES

The purposes, advantages and characteristics of the present invention will become apparent from the detailed description below in reference to the following figures:

FIG. 1 is an exploded perspective view of a first exemplary embodiment of a watch according to the invention comprising a shock-resistant dial;

FIG. 2 is a cross-sectional view partially illustrating the first exemplary embodiment of the watch illustrated in FIG. 1;

FIG. 3 is a cross-sectional view partially illustrating a shock-resistant dial according to the invention;

FIG. 4 is a partial cross-sectional view of the second exemplary embodiment of a watch according to the invention.

In all of the figures, common elements have the same reference numbers unless otherwise specified.

### DETAILED DESCRIPTION OF THE INVENTION

In the present application, the axial direction is a direction extending perpendicularly to a plane formed by the dial of the horology movement, referenced here as P1. On the other hand, a radial direction is parallel to the plane P1 formed by the dial.

The terms “inner” and “outer” are to be considered with reference to the centre of the timepiece, so that an inner face is closer to the centre than an outer face which is opposite the centre of the timepiece.

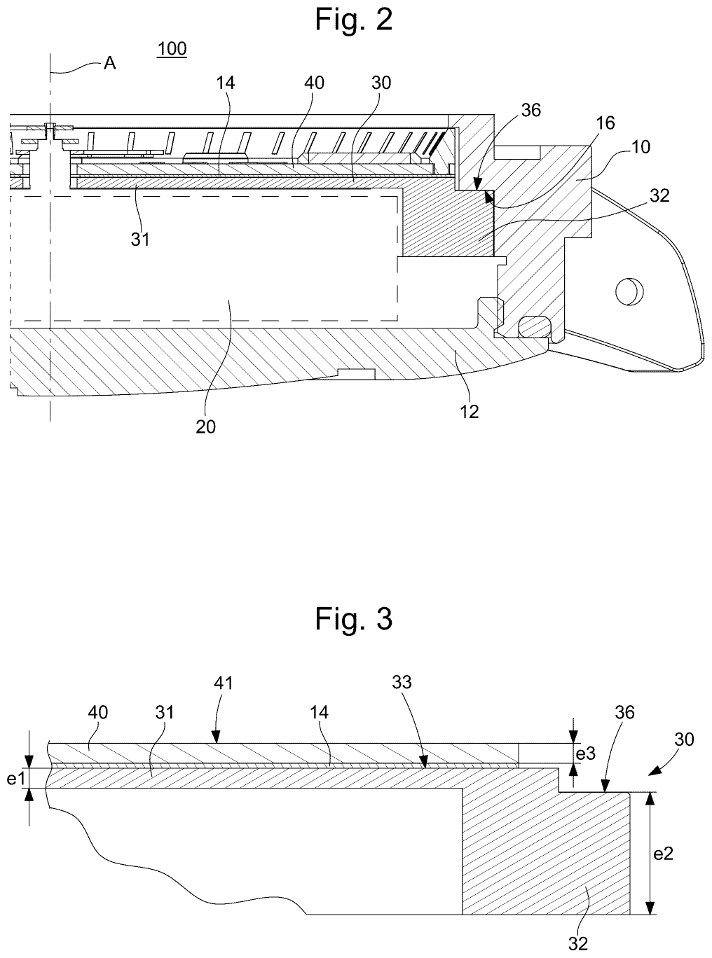

The terms “upper” and “lower” are to be considered in reference to a watch placed on its back as shown in FIG. 2.

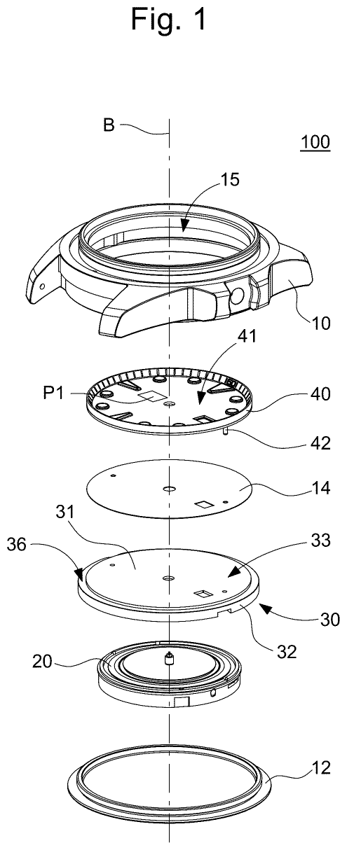

FIG. 1 is an exploded perspective view of a first exemplary embodiment of a watch 100 according to the invention, with a central axis B, comprising a middle 10 configured to be closed on either side by a detachable back 12 and a glass (not shown).

FIG. 2 is a cross-sectional view partially illustrating the first exemplary embodiment of the watch 100 illustrated in FIG. 1. FIG. 3 is a cross-sectional view illustrating more specifically a shock-resistant dial according to the invention.

For example, the middle 10 is made of metal, ceramic, polymer or a combination of different materials.

The watch 100 comprises a movement 20 housed in an inner volume 15 delimited by the middle 10 and held in position in the middle 10 by casing means (not shown).

The movement 20 can be mechanical, electromechanical or electronic.

The movement 20 has a central axis A perpendicular to a general plane P1. The central axis A of the movement 20 is parallel or corresponds to the rotational axis of the hands of the movement.

The central axis A of the movement 20 is parallel or corresponds to the central axis B of the middle 110.

A dial 40 is conventionally positioned above the movement 20 and is visible through the glass.

The dial 40 has an upper surface 41, visible to the user, bearing indicators and/or openings for displaying time-related information. The dial 40 can also have a decoration on its upper surface 41.

For example, the dial is made of brass, aluminium, steel, a metal alloy, synthetic material, composite materials or a blend of these materials.

The dial has a thickness e₃. Conventionally, the dial is 0.4 mm thick. Depending on the material used for the dial and depending on its dimensions, such a thickness can lead to rigidity problems and cause distortions if the watch 100 is subjected to a shock.

To remedy this drawback, the dial 40 is attached to a reinforcement piece 30, positioned under the dial 40, the assembly forming a shock-resistant dial according to the invention.

The dial 40 has a central portion and a peripheral portion. According to the invention, the central portion and the peripheral portion of the dial 40 press against the reinforcement piece 30.

For example, the reinforcement piece 30 is disc-shaped, with a central portion 31 and a peripheral portion 32.

Preferentially, the reinforcement piece 30 has a radial dimension greater than the radial dimension of the dial 40, such that the dial 40 is integrally pressed against the reinforcement piece 30.

The reinforcement piece 30 has an upper surface 33 forming a supporting surface on which the dial 40 is pressed and attached.

The reinforcement piece 30 comprises an annular shoulder 36 formed in the peripheral portion 32 configured to press against an annular shoulder 16 formed in an inner portion of the middle 10.

Preferentially, the peripheral portion 32 has, at the annular shoulder 36, a thickness e₂ greater than the thickness e₁ of the central portion 31 and has a thickness e₃ of the dial 40. For example, the peripheral portion 32 is at least twice as thick as the central portion 31 so as to ensure the rigidity of the thinner dial 40.

The reinforcement piece 30 is attached to the middle 10 and presses against the annular shoulder 16 at the peripheral annular shoulder 36.

In this first exemplary embodiment illustrated in FIGS. 1 and 2, the reinforcement piece 30 is attached to the middle by screwing means, such as screws.

For example, the reinforcement piece 30 is attached to the middle 10 by means of screws that engage with tappings in the annular shoulder 16. The screwing means ensure that the reinforcement piece 30 is rigidly held against the annular shoulder 16 of the middle 10.

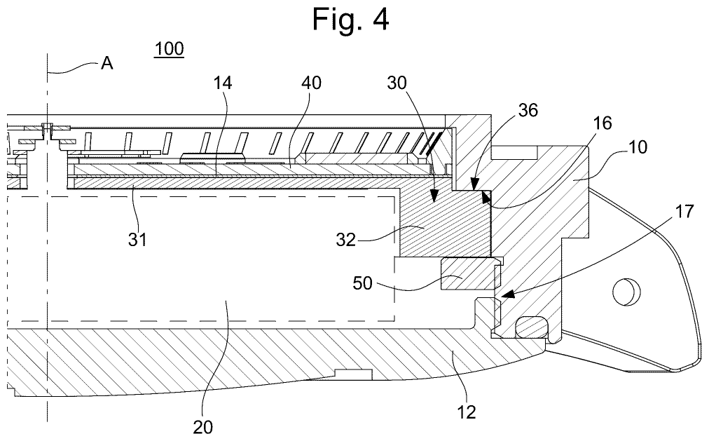

In a second exemplary embodiment illustrated in FIG. 4, the reinforcement piece 30 is rigidly attached to the middle 10 by means of a clamp ring 50, separate from the detachable back 12. The clamp ring 50 is screwed into the middle 10 and configured to clamp and axially compress the reinforcement piece 30 against the annular shoulder 16 of the middle 10.

The clamp ring 50 comprises, on its outer circumference, a threading configured to engage with a tapping 17 formed on an axial inner face of the middle 10.

The clamp ring 50 can comprise impressions on its lower face, enabling a tool to be inserted to make it easier to clamp the clamp ring 50 in the middle 10.

Preferentially, the tapping 17 for clamping the clamp ring 50 is identical to the tapping for mounting and tightening the detachable back 12.

The clamp ring 50 can be made of any rigid, non-elastomer material, for example metal or a synthetic material.

For example, the clamp ring 50 is made from a rigid, non-elastomer material with a Young's modulus greater than 50 GPa.

Preferentially, the reinforcement piece 30 covers the movement 20 integrally and has the necessary openings for displaying information on the dial 40.

The reinforcement piece 30 can be arranged in contact with the movement 20, for example in contact with the upper face of the movement 20. The reinforcement piece 30 can also be positioned at a distance from the movement 20 so as to have an axial gap between the reinforcement piece 30 and the movement 20.

The dial 40 can conventionally comprise fastening lugs 42 that engage with ports formed in the central portion 31 of the reinforcement piece 30. These fastening lugs 42 form an indexing means for correctly positioning the dial 40 on the reinforcement piece 30.

For example, the dial 40 is glued to the reinforcement piece 30 using an adhesive element 14, for example an adhesive film.

The adhesive element 14 thus forms an interface layer between the dial 40 and the reinforcement piece 30.

For example, the dial 40 is screwed onto the reinforcement piece 30, for example by screws that engage with tappings formed on the upper face 33 of the reinforcement piece 30.

For example, the dial 40 is soldered or brazed onto the reinforcement piece 30.

By way of example, the dial 40 is made of brass and has a thickness e₃ of 0.4 mm. The reinforcement piece 30 is made of steel and has a thickness e₁ of 0.4 mm and a thickness e₂ of 0.9 mm.

In a variant embodiment, the dial 40 is made in one piece with the reinforcement piece 30, for example. In this variant embodiment, the decorative surface is applied directly to the reinforcement piece 30.

1. A watch comprising:
a middle;
a detachable back mounted on the middle;
a movement housed in an inner volume of the middle; and
a dial, with a thickness (e₃), comprising an upper face visible to the user, the dial being attached to a reinforcement piece positioned under the dial, the reinforcement piece comprising a peripheral annular shoulder engaging with an annular shoulder formed in the middle, said reinforcement piece being attached to the middle and pressing against the annular shoulder of the middle.

2. The watch according to claim 1, wherein the dial is rigidly pressed against an upper face of the reinforcement piece.

3. The watch according to claim 2, wherein the dial has a central portion and a peripheral portion and in that the central portion and the peripheral portion are rigidly pressed against the upper face of the reinforcement piece.

4. The watch according to claim 1, wherein the reinforcement piece has a central portion with a thickness (e₁) and a peripheral portion on which the peripheral annular shoulder is formed, the peripheral portion having a thickness e₂, the thickness (e₂) of the peripheral portion being greater than the thickness (e₁) of the central portion and greater than the thickness e₃ of the dial.

5. The watch according to claim 4, wherein the thickness (e₂) of the peripheral portion is at least twice the thickness (e₁)of the central portion and/or greater than the thickness (e₃) of the dial.

6. The watch according to claim 1, wherein the reinforcement piece is attached to the middle by screwing.

7. The watch according to claim 6, wherein the reinforcement piece is attached to the middle by screwing it onto the annular shoulder of the middle.

8. The watch according to claim 1, further comprising a clamp ring, separate from the detachable back, screwed into the middle and designed to axially compress the reinforcement piece against the annular shoulder of the middle.

9. The watch according to claim 8, wherein the clamp ring comprises, on an outer circumference, a threading that engages with a tapping formed in the middle.

10. The watch according to claim 9, wherein the tapping in the middle for clamping the clamp ring is configured such that the detachable back can be screwed thereon.

11. The watch according to claim 1, wherein the dial is made in one piece with the reinforcement piece.

12. The watch according to claim 2, wherein the dial is glued to the upper face of the reinforcement piece using an adhesive element.

13. The watch according to claim 2, wherein the dial is screwed onto the upper face of the reinforcement piece by screwing means.

14. The watch according to claim 2, wherein the dial is attached by brazing or soldering to the upper face of the reinforcement piece.

15. The watch according to claim 1, wherein the movement is cased in the middle using the reinforcement piece.
